(19) United States
(12) Patent Application Publication
(10) Pub. No.: US 2026/0118189 A1
(43) Pub. Date: Apr. 30, 2026

(54) Triboelectric Self-Powered Pressure Sensor And Method

(71) Applicant: Wisconsin Alumni Research Foundation, Madison, WI (US)

(72) Inventors: Joseph ANDREW, Madison, WI (US); Vanessa BARTON, Madison, WI (US)

(21) Appl. No.: 18/933,258

(22) Filed: Oct. 31, 2024

(51) Int. Cl. G01L 1/00; G01L 25/00

(52) U.S. Cl. CPC G01L 1/005; G01L 25/00

(57) ABSTRACT

A pressure sensor and method of sensing pressure are provided. The pressure sensor includes first and second electrodes positionable in proximity to each other. A friction layer is in proximity to the first and second electrodes and is slidable with respect to the first and second electrodes in response to a physical force exerted thereon. Open circuit voltages are generated across each of the first and second electrodes in response to the sliding of the friction layer with respect to the first and second electrodes. The physical force exerted on the friction layer is determined in response to the open circuit voltages across each of the first and second electrodes.

### REFERENCE TO GOVERNMENT GRANT

This invention was made with government support under N00014-21-1-2851 awarded by the NAVY/ONR. The government has certain rights in the invention.

### FIELD OF THE INVENTION

This invention relates generally to sensors, and in particular to a pressure sensor and method of sensing pressure over a wide pressure range and with high temporal resolution.

### BACKGROUND AND SUMMARY OF THE INVENTION

Pressure sensors play a vital role in providing valuable information in a wide array of applications, including health monitoring, robotics, and wearable devices. To date, research efforts have greatly improved the sensitivity of sensors and their performance in ultrasensitive applications. However, these sensors often face limitations in their pressure range, with most focusing on optimizing the sensor's operation in the low and ultralow ranges. For intermediate, high-pressure, and high-speed applications, a sensor with a wide pressure range and high temporal resolution is exceedingly desirable.

Recent sensor designs operate utilizing mechanisms including microelectromechanical systems (MEMS), piezoresistive, field-effect transistors, triboelectric, and capacitive. Piezoresistive and capacitive sensing mechanisms have been particularly successful in achieving high sensitivities and low detection limits, but each mechanism has certain disadvantages. One disadvantage that most mechanisms share is that they require an external power supply, with some mechanisms such as piezoresistive, requiring more power than others. This need for a power supply leads to several problems. For example, concerning wearable applications, batteries are comparatively large and rigid leading to discomfort.

In recent years, rapid development in the field of nanogenerators has highlighted a path forward in self-powered sensing devices. Currently, many self-powered pressure sensors rely on contact-separation triboelectric designs with complex microstructures, such as prisms, pores, and hemispheres. In contact-separation designs, the sensors use contact electrification to detect pressure. When two different materials contact, they generate charges on the surface of the materials. Upon release, the materials separate and the charges create a potential across the monitored electrodes. The microstructures allow the sensors to be sensitive to low pressures, as the dielectric layer compresses rapidly under low pressures, increasing the contact area. However, once the structure collapses or the materials completely contact, the sensor is unable to detect changes in pressure. Not only does this limit the pressure range of the sensor, but it also means the sensors are more challenging to fabricate and are more likely to break under repeated loading.

Therefore, it is a primary object and feature of the present invention to provide a pressure sensor and method of sensing pressure over a wide pressure range and with high temporal resolution.

It is a further object and feature of the present invention to provide a pressure sensor and method of sensing pressure that is more robust than prior pressure sensors.

It is a still further object and feature of the present invention to provide a pressure sensor and method of sensing pressure that is simple to manufacture and inexpensive to implement.

In accordance with the present invention, a pressure sensor is provided. The pressure sensor includes first and second electrodes positionable in proximity to each other. A friction layer is provided in proximity to the first and second electrodes. The friction layer is slidable with respect to the first and second electrodes in response to a physical force exerted thereon. Open circuit voltages are generated across each of the first and second electrodes in response to the sliding of the friction layer with respect to the first and second electrodes.

Each of the first and second electrodes include a base portion having a plurality of legs projecting therefrom. The plurality of legs of the first electrode are interdigitated with the plurality of legs of the second electrode. An electrode layer having a first face directed towards the friction layer and is defined by first and second sublayers. The first and second electrodes are captured between the first and second sublayers of the electrode layer. A lubricant may be disposed between the first face of the electrode layer and the friction layer. The first and second sublayers of the electrode layer may be formed from polyimide and the friction layer may be formed from polydimethylsiloxane (PDMS).

The pressure sensor may also include a processing unit. The processing unit is configured to measure the open circuit voltages across each of the first and second electrodes and sum open circuit voltages across each of the first and second electrodes. The physical force exerted on the friction layer is determined in response to the summed open circuit voltages. It is contemplated for the physical force exerted on the friction layer to be pressure.

In accordance with a further aspect of the present invention, a pressure sensor is provided. The pressure sensor includes an electrode layer having an engagement surface;
a first electrode having a plurality of legs; and a second electrode in proximity to the first electrode and having a plurality of legs. A friction layer is slidably receivable on the engagement surface of the electrode layer. The friction layer is slidable on the engagement surface in response to a physical force exerted thereon and open circuit voltages are generated across each of the first and second electrodes in response to the sliding of the friction layer on the engagement surface of the electrode layer.

The plurality of legs of the first electrode are interdigitated with the plurality of legs of the second electrode. In addition, the electrode layer includes first and second sublayers. The first and second electrodes are captured between the first and second sublayers of the electrode layer. The first and second sublayers of the electrode layer may be formed from polyimide. A lubricant may be disposed between the engagement face of the electrode layer and the friction layer. The friction layer may be formed from polydimethylsiloxane (PDMS).

The pressure sensor may further include a processing unit. The processing unit is configured to measure the open circuit voltages across each of the first and second electrodes and sum open circuit voltages across each of the first and second electrodes. The physical force exerted on the friction layer is determined in response to the summed open circuit voltages. It is contemplated for the physical force exerted on the friction layer to be pressure.

In accordance with a still further aspect of the present invention, a method of sensing pressure is provided. The method includes the steps of positioning a friction layer in proximity to first and second electrodes and exerting a pressure on the friction layers so as to cause the friction layer to slide with respect to the first and second electrodes. Open circuit voltages across each of the first and second electrodes are measured. The open circuit voltages are generated in response to the sliding of the friction layer with respect to the first and second electrodes. The open circuit voltages across each of the first and second electrodes are summed and the pressure exerted on the friction layer is determined in response to the summed open circuit voltages.

The friction layer includes first and second surfaces and the first and second electrodes lie in a plane. The pressure on the friction layer is generated at an angle perpendicular to the first and second surfaces of the friction layer. Each of the first and second electrodes include a base portion having a plurality of legs projecting therefrom. The plurality of legs of the first electrode are interdigitated with the plurality of legs of the second electrode. The first and second electrodes are within an electrode layer. For example, the electrode layer includes first and second sublayers. The first and second electrodes can be captured between the first and second sublayers of the electrode layer.

It is contemplated for the first and second sublayers of the electrode layer to be formed from polyimide and for the friction layer is formed from polydimethylsiloxane (PDMS).

Lubricant may be provided on the friction layer.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings furnished herewith illustrate a preferred methodology of the present invention in which the above advantages and features are clearly disclosed as well as others which will be readily understood from the following description of the illustrated embodiment.

In the drawings:

FIG. 1 is a schematic, isometric view of a pressure sensor in accordance with the present invention;

FIG. 2 is a cross-sectional view of the pressure sensor of the present invention taken along line 2-2 of FIG. 1;

FIG. 3 is an exploded view of the pressure sensor of FIG. 1;

FIG. 4 is a top plan of a first sublayer of an electrode layer of the pressure sensor of FIG. 1;

FIG. 5 is a cross-sectional view, similar to FIG. 2, schematically representing the pressure sensor of the present invention in operation;

FIG. 6 is a graphical representative plot showing open circuit voltages versus time during operation of the pressure sensor of the present invention;

FIG. 7 is a graphical representative plot showing summed open circuit voltages versus time during operation of the pressure sensor of the present invention; and

FIG. 8 is a graphical representative plot showing voltage integrals versus stress for data obtained during the testing of the pressure sensor of the present invention.

### DETAILED DESCRIPTION OF THE DRAWINGS

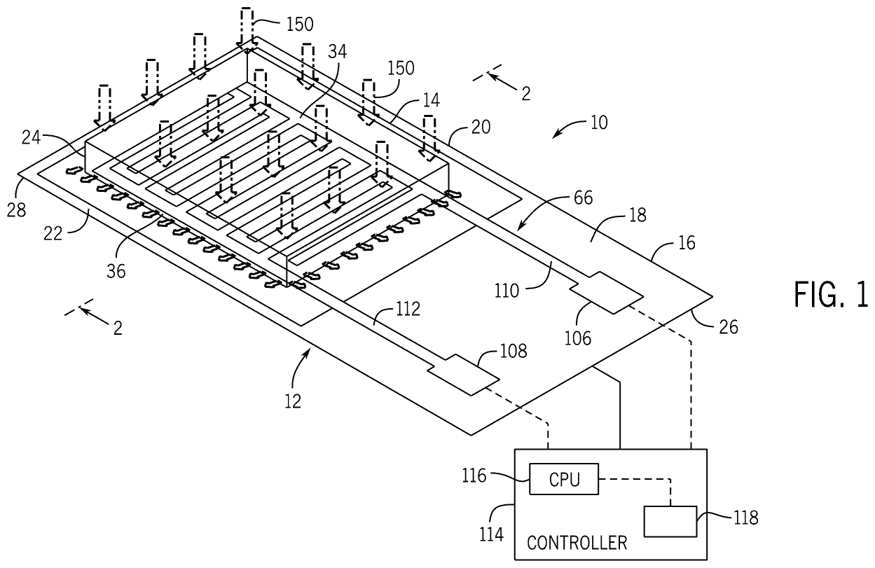

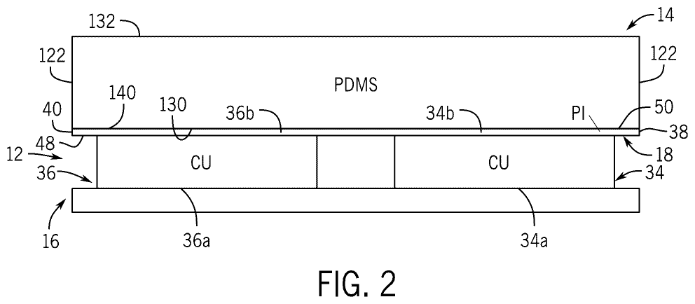

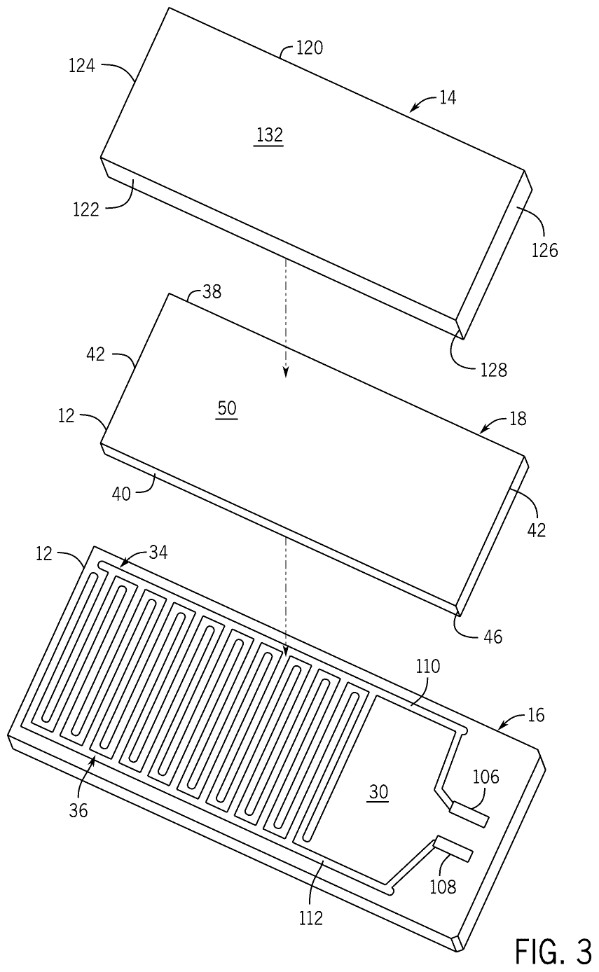

Referring to FIGS. 1-5, a pressure sensor in accordance with the present inventions is generally designated by the reference numeral 10. In the depicted embodiment, pressure sensor 10 includes an electrode layer 12 fabricated from polymer, e.g. polyimide (PI), and a friction layer 14 fabricated from a polymer, e.g. polydimethylsiloxane (PDMS).

Electrode layer 12 is defined by first and second sublayers 16 and 18, respectively. In the depicted embodiment, first sublayer 16 has a generally rectangular configuration and is defined by first and second sides 20 and 22, respectively, and first and second ends 24 and 26, respectively, which define outer periphery 28 thereof. However, configurations are possible without deviating from the scope of the present invention. First sublayer 16 includes inner face 30 and outer face 32 which defines a lower face of electrode layer 12. Interdigitated, first and second electrodes 34 and 36, respectively, are positioned on inner face 30 of first sublayer 16, as hereinafter described. It is contemplated for interdigitated, first and second electrodes 34 and 36, respectively, to be fabricated from copper. However, it can be understood that first and second electrodes 34 and 36, respectively, may be fabricated from other materials without deviating from the scope of the present invention.

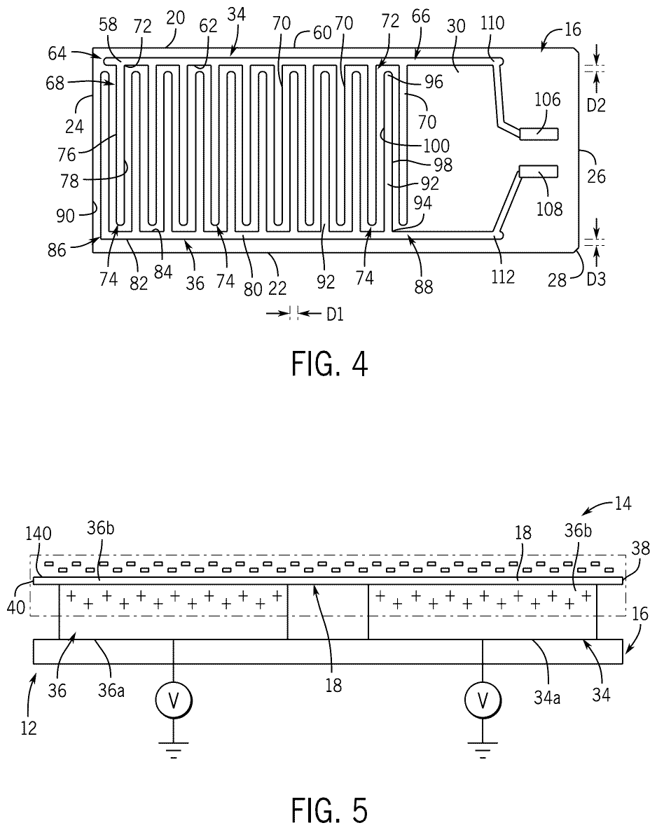

As best seen in FIGS. 1 and 4, first and second electrodes 34 and 36, respectively, have generally comb-like shapes. More specifically, first electrode 34 includes an elongated base portion 58 having a first side 60 spaced from and generally parallel to first side 20 of first sublayer 16, a second side 62 spaced from and generally parallel to second side 22 of first sublayer 16, a first end 64 spaced from first end 24 of first sublayer 16 and a second end 66 spaced from second end 26 of first sublayer 16. A plurality of spaced legs 68 project from second side 62 of first electrode 34 along corresponding axes toward second side 22 of first sublayer 16. Each leg 70 of the plurality of spaced legs 68 is defined by a first end 72 integral with second side 62 of base portion 58 of first electrode 34 and an opposite, terminal end 74. First end 72 and terminal end 74 of each leg 70 are interconnected by first and second parallel sides 76 and 78, respectively, which are perpendicular to second side 62 of base portion 58 of first electrode 34 and parallel to first and second ends 24 and 26, respectively, of first sublayer 16.

Similarly, second electrode 36 includes an elongated base portion 80 having a first side 82 spaced from and generally parallel to second side 22 of first sublayer 16, a second side 84 spaced from and generally parallel to second side 62 of base portion 58 of first electrode 34, a first end 86 spaced from first end 24 of first sublayer 16 and a second end 88 spaced from second end 26 of sublayer 16. A plurality of spaced legs 90 project from second side 84 of second electrode 36 along corresponding axes toward second side 62 of base portion 58 of first sublayer 16. The plurality of spaced legs 90 of second electrode 36 are interdigitated with the plurality of spaced legs 68 of first electrode 34 such that each leg 92 of the plurality of spaced legs 90 of second electrode 36 is spaced from an adjacent leg 70 of the plurality of spaced legs 68 of first electrode 34 by a distance D1, e.g. 0.5 millimeters (mm).

Each leg 92 of the plurality of spaced legs 90 of second electrode 36 is defined by a first end 94 integral with second side 84 of base portion 80 of second electrode 36 and an opposite, terminal end 96. Terminal end 96 of each leg 92 of the plurality of spaced legs 90 of second electrode 36 is spaced from second side 62 of base portion 58 of first electrode 34 by a distance D2, e.g. 0.5 mm. Likewise, terminal end 74 of each leg 70 of the plurality of spaced legs 68 of first electrode 34 is spaced from second side 84 of base portion 80 of second electrode 36 by a distance D3, e.g. 0.5 mm. In addition, first end 94 and terminal end 96 of each leg 92 of the plurality of spaced legs 90 of second electrode 36 are interconnected by first and second parallel sides 98 and 100, respectively, which are perpendicular to second side 84 of base portion 80 of second electrode 36 and parallel to first and second ends 24 and 26, respectively, of first sublayer 16.

Signal traces 106 and 108, respectively, are bonded to inner face 30 of first sublayer 16 at a location adjacent second end 26 of first sublayer 16. It is contemplated for signal traces 106 and 108 to be fabricated from copper. However, it can be understood that signal traces 106 and 108 may be fabricated from other materials without deviating from the scope of the present invention. Signal trace 106 is electrically coupled to second end 66 of base portion 68 of first electrode 34 by trace 110. Signal trace 108 is electrically coupled to second end 88 of base portion 80 of second electrode 36 by trace 112. Traces 110 and 112 may have various configurations, e.g. straight in FIG. 1 and angled in FIG. 4, without deviating from the scope of the present invention.

In the depicted embodiment, second sublayer 18 of electrode layer 12 has a generally rectangular configuration and is defined by first and second sides 38 and 40, respectively, and first and second ends 42 and 44, respectively, which define outer periphery 46 thereof. However, it can be understood that second sublayer 18 of electrode layer 12 may have different configurations without deviating from the scope of the present invention. Second sublayer 16 further includes inner face 48 directed towards inner face 30 of first sublayer 16 and upper face 50. Inner face 48 of second sublayer 16 is bonded to inner face 30 of first sublayer 16 so as to capture first and second electrodes 34 and 36, respectively, therebetween. More specifically, first sides 34a and 36a, respectively, of first and second electrodes 34 and 36, respectively, engage inner face 30 of first sublayer 16 and second sides 34b and 36b, respectively, of first and second electrodes 34 and 36, respectively, engage inner face 48 of second sublayer 18.

With inner face 48 of second sublayer 16 bonded to inner face 30 of first sublayer 16, first and second sides 20 and 22, respectively, of first sublayer 16 are generally coplanar with corresponding first and second sides 38 and 40, respectively, of second sublayer 18; and first end 24 of first sublayer 16 is generally coplanar with first end 42 of second sublayer 18. Further, with inner face 48 of second sublayer 16 is bonded to inner face 30 of first sublayer 16, first and second electrodes 34 and 36, respectively, are sandwiched between first and second sublayers 16 and 18, respectively, for mechanical and environmental stability. In the depicted embodiment, second end 44 of second sublayer 18 is spaced from second end 26 of first layer 16, thereby leaving signal traces 106 and 108 exposed.

Referring back to FIG. 1, first and second electrodes 34 and 36, respectively, are operatively connected to a controller, generally designated by the reference numeral 114. Controller 114 includes central processing unit 116 and non-transient memory storage, such as non-volatile memory 118. Controller 114, in turn, is operatively connected to first conductor 34 via signal trace 106 and trace 110 and to second conductor 108 via signal trace 108 and trace 112 in any conventional manner. It is intended for central processing unit 116 to be configured to execute a program stored in memory 118 to effectuate the methodology of the present invention, as hereinafter described. More specifically, it is intended for controller 114 to measure the open circuit voltages across first and second electrodes 34 and 36, respectively.

In the depicted embodiment, friction layer 14 of pressure sensor 10 has a generally rectangular configuration and is defined by first and second sides 120 and 122, respectively, and first and second ends 124 and 126, respectively, which define outer periphery 128 thereof. However, it can be understood that friction layer 14 may have different configurations without deviating from the scope of the present invention. Friction layer 14 includes inner face 130 directed toward electrode layer 12 and outer face 132 which defines an upper face of pressure sensor 10. It is contemplated for friction layer 14 to be fabricated from PDMS with a predetermined base and curing agent ratio, e.g. 20:1, which is thoroughly mixed, degassed, and poured into an acrylic mold to cure at selected temperature, e.g. room temperature, for a selected time period, e.g. 48 hours. In order to assemble pressure sensor 10, friction layer 14 is positioned on electrode layer 12 such that inner face 130 of friction layer 14 forms a slidable interface with upper face 50 of second sublayer 18 of electrode layer 12. A lubricant 140 is provided on inner face 130 of friction layer 14 to facilitate the sliding of friction layer 14 on upper face 50 of second sublayer 18 of electrode layer 12.

Due to triboelectrification, it can be understood that during the sliding process, an electrical charge is transferred between friction layer 14 and first and second electrodes 34 and 36, respectively. More specifically, in operation, a compressive force or pressure, generally depicted by arrows 150 in FIG. 1, is exerted on outer face 132 of friction layer 14. As a uniaxial compression is exerted on outer face 132 of friction layer 14, friction layer 14 will expand significantly. As friction layer 14 expands, friction along first and second electrodes 34 and 36, respectively, will be generated, thereby inducing surface charges thereon, FIG. 5. As is known, PDMS is a known electron acceptor and copper is a known electron donor within the triboelectric series. As a result, opposite charges will accumulate on the surfaces of first and second electrodes 34 and 36, respectively, which can be measured as positive voltage potentials through open circuit voltages at signal traces 106 and 108. Similarly, upon unloading, first and second electrodes 34 and 36, respectively, will again exchange electrons with friction layer 14 to balance the charges, resulting in negative open circuit voltages at signal traces 106 and 108. It can be appreciated that the operating pressure range and sensitivity can be tuned by simply modifying the mechanical properties of material from which friction layer 14 is formed. For example, in the depicted embodiment, the mechanical properties of the PDMS from which friction layer 14 is formed may be modified through temperature, mixing ratio, or surface modification so that friction layer 14 compresses and expands under the desired pressures with optimal friction. For example, a softer friction layer 14 will result in more compression and expansion at lower pressures and potentially higher friction, while a firmer friction layer 14 will result in a larger pressure range and potentially lower friction.

In order to test pressure sensor 10, a quasi-static uniaxial compression test was conducted utilizing a universal testing machine equipped with a predetermined, load cell capacity. Pressure sensor 10 was loaded in the universal testing machine under uniaxial compression or stress exerted on outer face 132 of friction layer 14 (e.g. 5.5 megapascals (MPa)) at selected loading and unloading rates, e.g. at 100% and 50% of initial height of friction layer 14 in order to achieve strain values of 75% (hereinafter referred to as 100% s⁻¹ loading and 50% s⁻¹ loading, respectively). The tests were repeated five times at each strain rate. Controller 114 is configured to measure the open circuit voltages on each of first and second electrodes 34 and 36, respectively, at selected sampling frequencies, e.g. approximately 32 kHz and 13 kHz for the 100% s⁻¹ loading rate and 50% s⁻¹ loading rate, respectively.

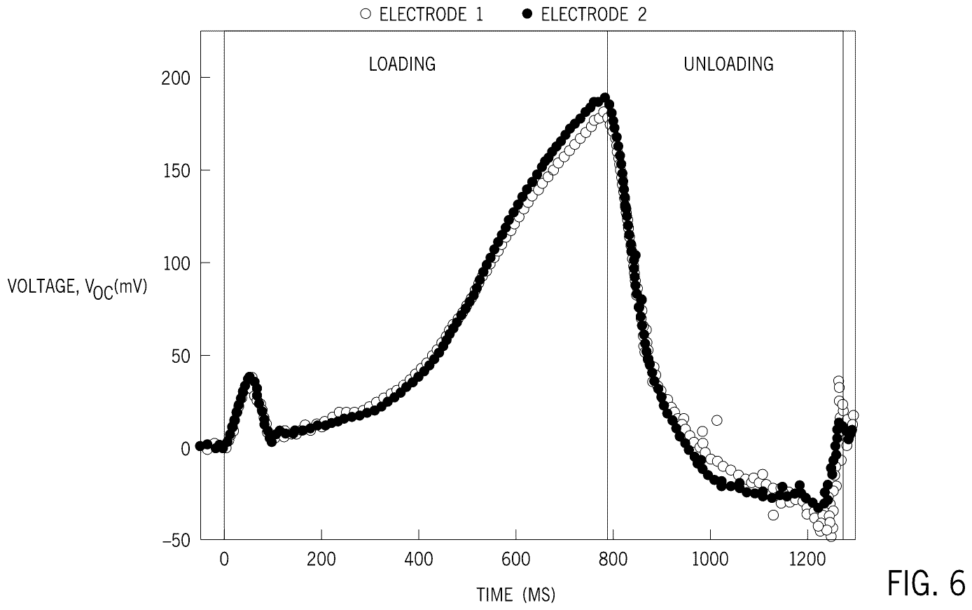

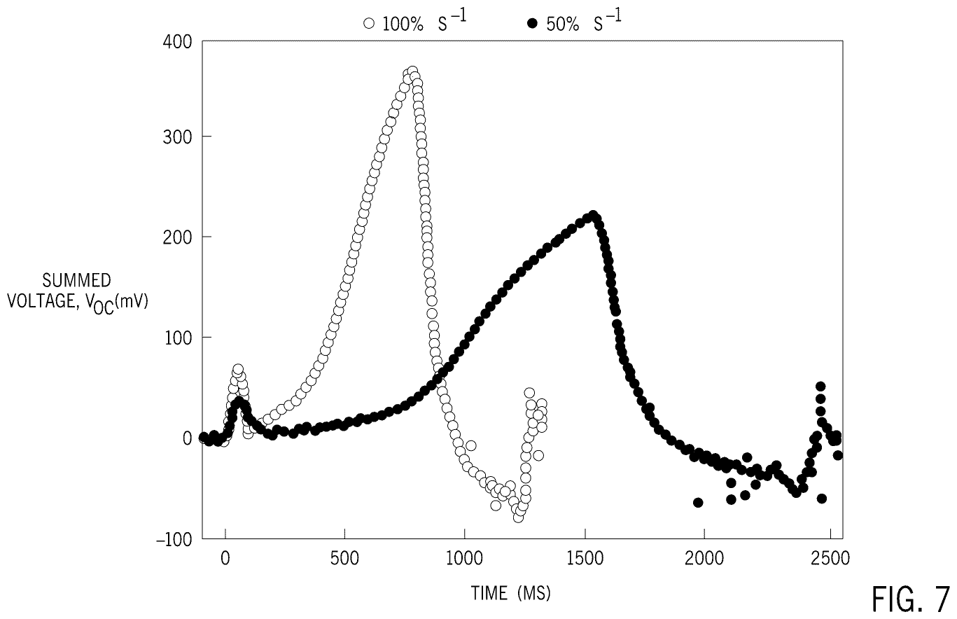

To determine the response of pressure sensor 10 during compression, controller 114 measured the open circuit voltages across first and second electrodes 34 and 36, respectively. FIG. 6 depicts shows the open circuit voltages across first and second electrodes 34 and 36, respectively, recorded during 100% s⁻¹ loading. It is noted that the open circuit voltages across first and second electrodes 34 and 36, respectively, were similar during both loading and unloading of pressure sensor 10, with the open circuit voltages across each of first and second electrodes 34 and 36, respectively, individually peaking at a voltage of approximately 190 millivolts (mV). It is further noted that at beginning of compression, an initial small peak in the open circuit voltages across first and second electrodes 34 and 36, respectively, occurred due to the initial static friction that friction layer 14 must overcome. In order to create a larger voltage potential signal, controller 114 summed the open circuit voltages across first and second electrodes 34 and 36, respectively.

Referring to FIG. 7, representative plots of summed open circuit voltages across first and second electrodes 34 and 36, respectively, at the strain rates incurred at 50% s⁻¹ loading and 100% s⁻¹ loading are depicted. It can be appreciated that the slower strain rate resulted in a loading time roughly twice as long as the faster strain rate. In addition, the peak of the summed open circuit voltages across first and second electrodes 34 and 36, respectively, at the slower strain rate is roughly two-thirds the magnitude of the summed open circuit voltages across first and second electrodes 34 and 36, respectively, at the faster strain rate. While the voltage peaks are significantly different, the maximum stress achieved differed by less than 5% on average. To address the obstacle of different voltage peaks for the same stress, controller 114 integrates the summed open circuit voltages across first and second electrodes 34 and 36, respectively, over time.

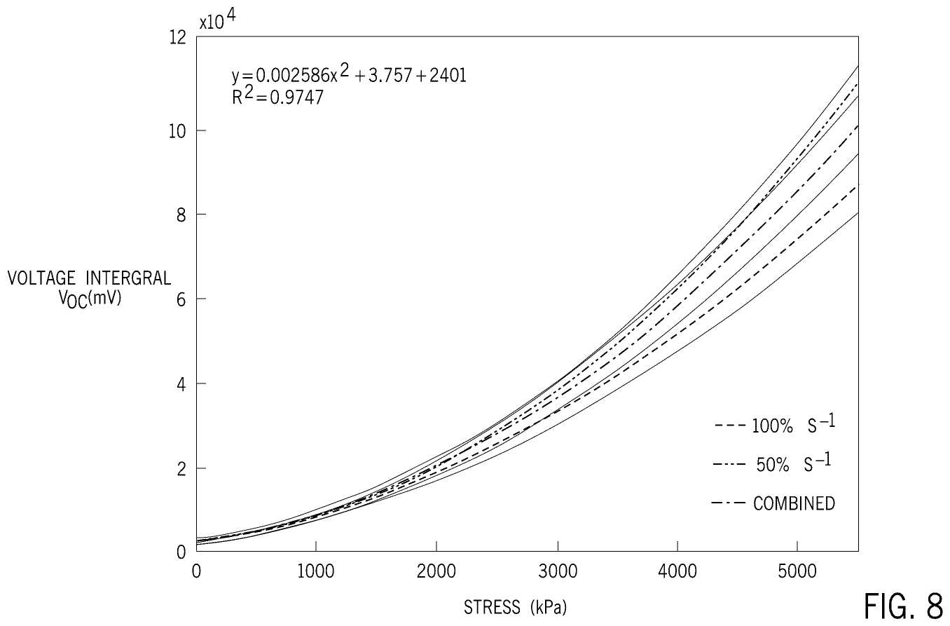

Referring to FIG. 8, a representative graph is provided which depicts the voltage integral of the summed open circuit voltages across first and second electrodes 34 and 36, respectively, versus the stress exerted on outer face 132 of friction layer 14 in the time domain for both strain rates. FIG. 4, in turn, is a representative graph depicting the voltage integral versus stress for each of the five tests conducts at each of the strain rates, namely, 100% s⁻¹ and 50% s⁻¹, along with the results of the combined data. It can be understood that unlike prior the sensitivity of prior triboelectric pressure sensors, the sensitivity of pressure sensor 10 increases with higher pressures rather than saturating. It can be appreciated that by integrating the summed open circuit voltages across first and second electrodes 34 and 36, respectively, over time, the pressure sensor 10 of the present invention allows for directly correlating the electrical response to the compressive force or pressure exerted on outer face 132 of friction layer 14, regardless of the strain rate, a significant advantage over the art.

As described, a self-powered pressure sensor 10 and method of sensing pressure over a wide pressure range and with high temporal resolution are provided. The fabrication process is simple and cost-efficient. Although the best mode contemplated by the inventors of carrying out the present invention is disclosed above, practice of the above invention is not limited thereto. It will be manifested that various additions, modifications and rearrangements of the features of the present invention may be made without deviating from the spirit and the scope of the underlying inventive concept.

It should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

We claim:

1. A pressure sensor, comprising:
an electrode; and
a friction layer in proximity to the electrode, the friction layer slidable with respect to the electrode in response to a physical force exerted thereon;
wherein an open circuit voltage is generated across the electrode in response to the sliding of the friction layer with respect to the electrode.

2. The pressure sensor of claim 1 further comprising an electrode layer having a first face directed towards the friction layer and being defined by first and second sublayers, the electrode being captured between the first and second sublayers of the electrode layer.

3. The pressure sensor of claim 2 further comprising a lubricant disposed between the first face of the electrode layer and the friction layer.

4. The pressure sensor of claim 2 wherein the first and second sublayers of the electrode layer are formed from polyimide.

5. The pressure sensor of claim 1 wherein the friction layer is formed from polydimethylsiloxane (PDMS).

6. The pressure sensor of claim 1 wherein the electrode is a first electrode and the pressure sensor further comprises a second electrode positionable in proximity to the first electrode, wherein each of the first and second electrodes include a base portion having a plurality of legs projecting therefrom, the plurality of legs of the first electrode interdigitated with the plurality of legs of the second electrode.

7. The pressure sensor of claim 6 further comprising a processing unit, the processing unit configured to:
measure the open circuit voltages across each of the first and second electrodes;
sum open circuit voltages across each of the first and second electrodes and to provide the same as a summed voltage; and
determine the physical force exerted on the friction layer in response to the summed voltage.

8. The pressure sensor of claim 1 wherein the physical force exerted on the friction layer is a pressure.

9. A pressure sensor, comprising:
an electrode layer including:
an engagement surface; and
an electrode
a friction layer slidably receivable on the engagement surface of the electrode layer, the friction layer slidable on the engagement surface in response to a physical force exerted thereon;
wherein an open circuit voltage is generated across the electrode in response to the sliding of the friction layer on the engagement surface of the electrode layer.

10. The pressure sensor of claim 9 wherein:
the electrode is a first electrode and has a plurality of legs; and
a second electrode is provided in proximity to the first electrode and has a plurality of legs; and
the plurality of legs of the first electrode are interdigitated with the plurality of legs of the second electrode.

11. The pressure sensor of claim 10 further comprising a processing unit, the processing unit configured to:
measure the open circuit voltages across each of the first and second electrodes;
sum open circuit voltages across each of the first and second electrodes and to provide the same as a summed voltage; and
determine the physical force exerted on the friction layer in response to the summed voltage.

12. The pressure sensor of claim 10 wherein the electrode layer includes first and second sublayers, the first and second electrodes being captured between the first and second sublayers of the electrode layer.

13. The pressure sensor of claim 12 wherein the first and second sublayers of the electrode layer are formed from polyimide.

14. The pressure sensor of claim 9 further comprising a lubricant disposed between the engagement face of the electrode layer and the friction layer.

15. The pressure sensor of claim 9 wherein the friction layer is formed from polydimethylsiloxane (PDMS).

16. The pressure sensor of claim 9 wherein the physical force exerted on the friction layer is a pressure.

17. A method of sensing pressure, comprising the steps of:
positioning a friction layer in proximity to an electrode;
exerting a pressure on the friction layer so as to cause the friction layer to slide with respect to the electrode;
measuring an open circuit voltage across the electrode, the open circuit voltage being generated in response to the sliding of the friction layer with respect to the electrode; and
determining the pressure exerted on the friction layer in response to the open circuit voltage across the electrode.

18. The method of claim 17 wherein;
the electrode is a first electrode;
a second electrode is provided in proximity to the first electrode and the friction layer;
the pressure exerted on the friction layer causes the friction layer to slide with respect to the first and seconds electrode;
the open circuit voltage across the second electrode is measured, the open circuit voltage across the second electrode is generated in response to the sliding of the friction layer with respect to the second electrode; and
the pressure exerted on the friction layer in response to the open circuit voltages across the first and second electrodes.

19. The method of claim 18 wherein:
the friction layer includes first and second surfaces;
the first and second electrodes lie in a plane; and
the pressure is generated at an angle perpendicular to the first and second surfaces of the friction layer.

20. The method of claim 18 wherein each of the first and second electrodes include a base portion having a plurality of legs projecting therefrom, the plurality of legs of the first electrode interdigitated with the plurality of legs of the second electrode.

21. The method of claim 18 further comprising the step of capturing the first and second electrodes within an electrode layer, the electrode layer including first and second sublayers configured to capture the first and second electrodes therebetween.

22. The method of claim 21 wherein the first and second sublayers of the electrode layer are formed from polyimide.

23. The method of claim 18 comprising the additional step of summing the open circuit voltages across each of the first and second electrodes prior to determining the pressure exerted on the friction layer.

24. The method of claim 17 comprising the additional step of providing a lubricant on the friction layer.

25. The method of claim 17 wherein the friction layer is formed from polydimethylsiloxane (PDMS).
